(19) United States
(12) Patent Application Publication
(10) Pub. No.: US 2024/0402774 A1
(43) Pub. Date: Dec. 5, 2024

(54) METHOD FOR CONTROLLING TOTAL POWER CONSUMPTION OF SYSTEM BY SETTING MAXIMUM ROTATION SPEED OF FAN

(71) Applicants: INVENTEC (PUDONG) TECHNOLOGY CORPORATION, Shanghai (CN); INVENTEC CORPORATION, Taipei (TW)

(72) Inventors: BIAO LI, Shanghai (CN); LIAN-FEI ZHANG, Shanghai (CN)

(21) Appl. No.: 18/220,276

(22) Filed: Jul. 11, 2023

(30) Foreign Application Priority Data
Jun. 1, 2023 (CN) 202310646221.5

(51) Int. Cl. G06F 1/26

(52) U.S. Cl. CPC G06F 1/26

(57) ABSTRACT

A method for controlling total power consumption of a system by setting maximum rotation speed of a fan is provided, which is applied to a system at least having a heat-generating element, a fan, and a controller. The method includes: setting a controller with a maximum rotation speed limit value of the fan; reading a rotation speed of the fan by the controller; and determining, by the controller, whether the rotation speed of the fan reaches the maximum rotation speed limit value, if yes, a pulse-width modulation value of the fan is set by the controller as a pulse-width modulation value upper limit corresponding to the maximum rotation speed limit value; therefore, a feedback is provided for the fan through the controller to control total power consumption of the system.

This application claims priority under 35 U.S.C. § 119 to Chinese Patent Application No. 202310646221.5, filed on Jun. 1, 2023, the entire content of which is incorporated herein in its entirety.

### TECHNICAL FIELD

The present application relates to a method for controlling total power consumption of a system by setting a maximum rotation speed of a fan, particularly relates to a method that determines whether the fan reaches the maximum rotation speed to control total power consumption of the system.

### BACKGROUND

In general, in the existing technologies, an overall server system needs to undergo a test on temperature and total power consumption of the overall system and so on under a designated specific environment and condition. The overall server system is configured internally to include at least the following devices: a central processing unit (CPU), a memory, a hard disk, a network card, a graphics processing unit (GPU), and the like. In addition, in one scenario of actual test, it is required that, under an environmental temperature of 25° C. for the overall system, instantaneous maximum total power consumption of the overall system is measured to be no more than 900 W.

For a condition under which an environmental temperature is 25° C., a setpoint (SP in abbreviation) temperature Tsp for safe operation of the graphics processing unit is 72° C., and a loading pressure is continuously increased from 10% to 100%, with one set of result obtained by performing a test for every 10% increment in the loading pressure. Duration of a single test is 20 minutes. Test results show that total power consumption of the overall system in a stable phase is less than 870 W. However, there are multiple power consumption peaks of the overall system, and a maximum transient power consumption pertaining to these peaks reaches 930 W, which is significantly higher than the total power consumption 900 W set for the overall system in the stable phase. In order to satisfy the requirement that the transient total power consumption does not exceed 900 W, it is necessary to eliminate these power consumption peaks of the overall system.

### SUMMARY

In view of the prior art, total power consumption of an overall system may generate multiple power consumption peaks, which is unstable. Therefore, obtaining relatively stable total power consumption of the overall system has become an urgent issue needs to be resolved.

To resolve the problem of prior arts, technical solution adopted is to set a maximum rotation speed of a fan to control system total power, which is applied to at least one heat-generating element, a fan, a controller and a system. The method includes: setting a controller with a maximum rotation speed limit value of the fan; reading a rotation speed of the fan by the controller; and determining, by the controller, whether the rotation speed of the fan reaches the maximum rotation speed limit value, if determination result is positive, setting, by the controller, a pulse-width modulation value of the fan as a pulse-width modulation value upper limit corresponding to the maximum rotation speed limit value; providing, a feedback for the fan through the controller to control total power consumption of the system;
according to an auxiliary technical measure derived from the above-mentioned essential technical measure, a step is further included: determining, by the controller, whether to launch a PID control speed strategy;
according to an auxiliary technical measure derived from the above-mentioned essential technical measure, the maximum rotation speed limit value is 75%-81% of the maximum rotation speed value of the fan. Preferably, the maximum rotation speed limit value is 78% of the maximum rotation speed value of the fan;
according to an auxiliary technical measure derived from the above-mentioned essential technical measure, if the controller determines a rotation speed of the fan does not reach the maximum rotation speed limit value, the controller sets a pulse-width modulation value of the fan as a pulse-width modulation value corresponding to a rotation speed;

In view of the above, since the method for controlling system total power consumption by setting maximum rotation speed of a fan is a method that determines whether a fan reaches a maximum rotation speed to control the system total power consumption. Therefore, the disclosure may definitely and effectively achieve a relatively stable system total power consumption.

Specific embodiment adopted by the present disclosure is further described in accordance with the accompanying embodiments and diagrams.

### BRIEF DESCRIPTION OF THE DRAWINGS

FIG. 1 is a schematic flow chart of a method for controlling total power consumption of a system by setting a fan maximum rotation speed according to a preferred embodiment of the present disclosure;

FIG. 2 is a schematic diagram of a structure for implementing a method for controlling total power consumption of a system by setting a fan maximum rotation speed according to a preferred embodiment of the present disclosure; and

FIG. 3 is an experimental data diagram based on a method for controlling total power consumption of a system by setting a fan maximum rotation speed according to a preferred embodiment of the present disclosure;
descriptions of reference numerals are as follows:
10: element;
20: baseboard management controller;
21: input unit;
22: storage unit;
23: calculation unit;
24: output unit;
30: complex programmable logic device;
40: fan;
S01˜S09: step.

### DETAILED DESCRIPTION OF THE EMBODIMENTS

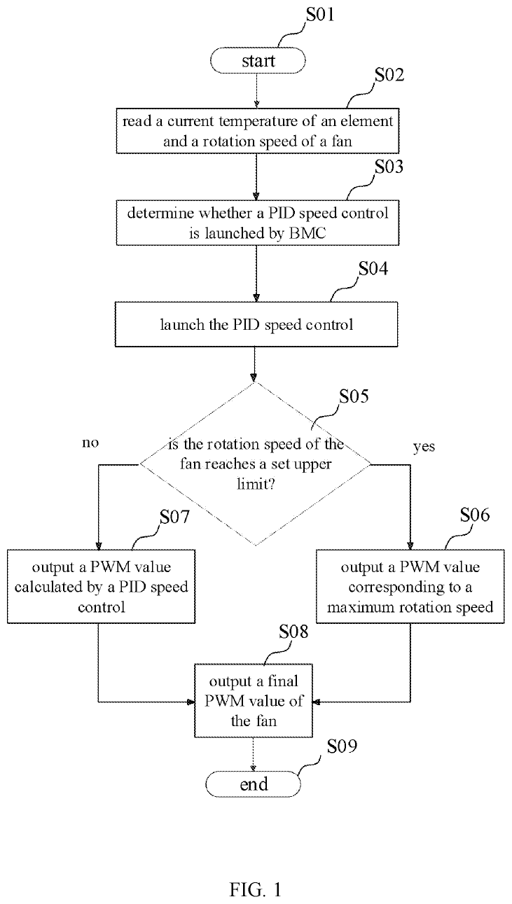

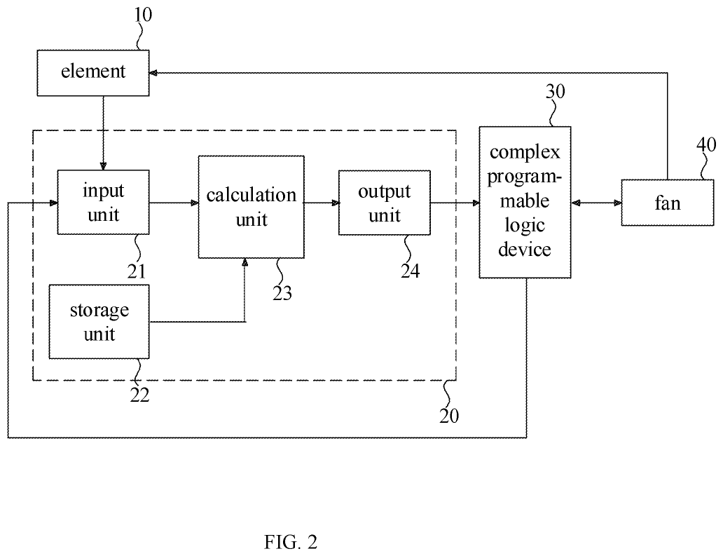

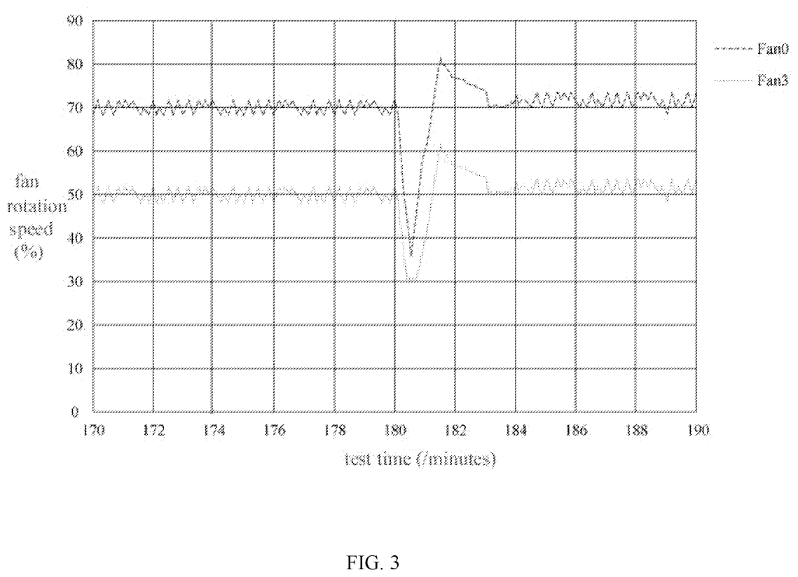

References may be made to FIG. 1 and FIG. 2. FIG. 1 shows a flow chart of a method for controlling total power consumption of a system by setting a maximum rotation speed of a fan provided by a preferred embodiment of the present disclosure. FIG. 2 shows a schematic diagram of a structure for implementing a method for controlling total power consumption of a system by setting a maximum rotation speed of a fan.

As shown in FIG. 1, a method for controlling total power consumption of a system by setting a maximum rotation speed of a fan 40 is disclosed by the present disclosure, such method is applied to a system at least including a heat-generating element, the fan 40, and a controller. The controller may be, for example, a baseboard management controller (BMC) 20, which contains a Proportion Integration Differentiation (PID) controller, or a PID control value is stored in a storage unit 22 of the BMC 20 and is for calculation by a calculation unit 23. The heat-generating element may be, for example, an element 10 shown in FIG. 2, which generally refers to an element that can generates heat, such as a central processing unit (CPU) or a graphics processing unit (GPU).

The method of the present disclosure includes: first, starting an experimental test process (Step S01), and setting the controller with a maximum rotation speed limit value of fan 40; next, reading a current temperature of element 10 and a rotation speed of fan 40 by the controller (Step S02); furthermore, determining, by the controller, whether to launch a PID speed control strategy (Step S03); if determination result is positive, launching the PID speed control strategy (Step S04).

The aforementioned PID speed control, which stands for “proportional, integral, derivative control”, has PID control values that include a proportional coefficient Kp, an integral coefficient Ki, and a derivative coefficient Kd. This is a commonly used control strategy for fan 40, which is usually activated during a loading pressurization test, with an objective to quickly adjust an appropriate rotation speed of fan 40 to meet a temperature control requirement of element 10.

Furthermore, the controller determines whether the rotation speed of fan 40 reaches a set upper limit, that is, the maximum rotation speed limit value (Step S05). If the rotation speed of fan 40 reaches the set maximum rotation speed limit value, the controller sets a pulse-width modulation (PWM) value of fan 40 as a PWM value upper limit corresponding to the maximum rotation speed limit value (Step S06), i.e., the controller outputs the PWM value upper limit corresponding to the maximum rotation speed limit value as a final current PWM value PWM(i) of the fan 40 being finally output (Step S08). Therefore, a feedback is provided by the controller to control the fan 40 such that a total power consumption of system is controlled.

If the rotation speed of fan 40 does not reach the set maximum rotation speed limit value, the controller sets a PWM value of fan 40 as a current PWM value PWM(i) corresponding to the rotation speed, that is, outputting a current PWM value PWM(i) calculated by the PID speed control strategy (Step S07). A specific way for calculation is described as follows: obtaining a current PWM value PWM(i) according to a PWM value of fan 40 PWM(i−1) at a previous moment and a PWM difference value Δ PWM(i) of fan 40, that is, PWM(i) is calculated according to the following formula: PWM(i)=PWM(i−1)+APWM(i). A specific way of calculating the PWM difference ΔPWM(i) of fan 40 is accomplished according to the following formula: ΔPWM(i)=Kp*[e(i)−e(i−1)]+Ki*e(i)+Kd*[T(i)−2*T(i−1)+T(i−2)], where e(i)=T(i)−Tsp; T(i) is a temperature of element 10 at an i-th moment, that is, a temperature at a current moment; Tsp is a setpoint temperature for safe operation of element 10; and Kp, Ki, and Kd are PID control values stored in baseboard management controller 20, which are a proportional coefficient, an integral coefficient, and a differential coefficient respectively.

Ultimately, according to the calculated value, a final current PWM value PWM(i) of fan 40 is output (Step S08) to control a rotation speed of fan 40. Thus, a feedback control is provided to fan 40 by the controller to control the total power consumption of the system. The experiment is ended (Step S09).

In addition, it needs to be particularly noted that a way of determination in Step S05 may be: first calculating a PWM value upper limit corresponding to the set maximum rotation speed limit value and calculating a current PWM value PWM(i) of fan 40 with the PWM value upper limit, through the PID speed control strategy in the controller, the PWM value upper limit and the PWM(i) are to be compared with each other; if the current PWM value PWM(i) of fan 40 calculated through the PID speed control strategy does not reach the calculated PWM value upper limit, outputting the current PWM value PWM(i) calculated through the PID speed control strategy; if the current PWM value PWM(i) of fan 40 calculated through the PID speed control strategy reach the calculated PWM value upper limit, or exceed the calculated PWM value upper limit, outputting the PWM value upper limit corresponding to the maximum rotation speed limit value.

Description of related hardware is presented as follows, and reference may be made to FIG. 2, which is a schematic diagram of a structure for implementing a method for controlling total power consumption of a system by setting a maximum rotation speed of fan 40 provided by a preferred embodiment of the present disclosure. The above-mentioned PID speed control strategy in the present disclosure is programmed into the baseboard management controller 20, and a specific control logic is as follows. The baseboard management controller 20 communicates with element 10 and a complex programmable logic device 30 (CPLD in abbreviation). An input unit 21 of the baseboard management controller 20 reads a temperature of element 10, a rotation speed of fan 40, and other information. A heat dissipation strategy (including a PID speed control strategy) stored in a storage unit 22 of the baseboard management controller 20 along with the above-mentioned information read by the input unit 21 are transmitted to a calculation unit 23 of the baseboard management controller 20. The calculation unit 23 determines whether the overall system platform is in a normal working state to decide whether to launch a PID speed control and a way of calculation in case of launching the PID speed control, and so forth. A calculated PWM difference value ΔPWM(i) of fan 40 is further transmitted as a fan control instruction to CPLD 30 by an output unit 24 of the baseboard management controller 20. The CPLD 30 further transmits the fan control instruction, which is transmitted by the baseboard management controller 20, to the fan 40. The fan 40 may determine whether and how to adjust its speed according to the fan control instruction sent by the CPLD 30, eventually completing a control of the fan 40 by the baseboard management controller 20. Additionally, the fan 40 transmits a fan signal, which includes information such as rotation speed, to the CPLD 30, and the CPLD 30 transmits its feedback to the input unit 21. Therefore, change in the rotation speed of fan 40 may cause a change in the temperature of element 10, which further counter reacts on the control by the baseboard management controller 20, achieving a bidirectional interaction between the temperature of element 10 and the rotation speed of fan 40.

Reference may be made to FIG. 3, which is an experimental data diagram of the method for controlling total power consumption of the system by setting the maximum rotation speed of fan 40.

For the test of the experiment, a specific loading pressure testing software is used to conduct the test of the experiment, which is particularly used for a graphics processing unit of the overall server system. During the experiment, power consumption of the graphics processing unit is momentarily halved and then quickly restored to full power, i.e., the power consumption is rapidly decreased and then rapidly increased, resulting in a rapid decrease followed by a rapid increase in temperature of the graphics processing unit. However, since both a heat dissipation risk point and a control point of fan 40 under a pressurized loading condition are in the graphics processing unit, that is, the graphics processing unit under the pressurized condition is the only element determining a rotation speed of fan 40, the graphics processing unit causes drastic fluctuations in the rotation speed of fan 40 at the end and beginning of each cycle.

Since the temperature of the graphics processing unit is closely related to the power consumption of the graphics processing unit, and the temperature of the graphics processing unit needs to be read before the rotation speed of fan 40 is adjusted, there is a certain delay in a response of the rotation speed of fan 40 to the power consumption of the graphics processing unit. This delay inevitably results in excessive adjustment of the rotation speed of fan 40, causing peaks in both the rotation speed of fan 40 and the power consumption, leading to peaks in the total power consumption of the system.

In view of the above-mentioned analysis, to reduce an impact of the graphics processing unit on the rotation speed of fan 40 during a process from an end to a restart of each cycle such that a goal of controlling the total power consumption of the overall system may be achieved, the following PID control strategy is proposed by the present disclosure. Under an environmental temperature of 25° C., a maximum rotation speed of fan 40 is set such that a power consumption of fan 40 and total power consumption of the overall system are limited. For example, a maximum rotation speed limit value of fan 40 is set to be 78%±3% of a maximum rotation speed value of fan 40, that is, a range from 75% to 81%. Setting the maximum rotation speed limit value of fan 40 as 78% of the maximum rotation speed value is to satisfy a power consumption configured by current overall system, if changes occur to machine platform configuration, wind guide structure and requirement on total power consumption of the overall system, appropriate adjustments need to be made to the maximum rotation speed limit value of fan 40. Through controlling the maximum rotation speed limit value of fan 40 to limit a maximum power consumption of fan 40, avoiding the rotation speed of fan 40 to be overly large and the power consumption to be exceedingly high, thereby achieving an objective to limit total power consumption of the overall system.

In addition, it needs to be noted that in order to reduce power consumption of fan 40, a two-zone speed control manner is adopted. As shown in FIG. 3, an upper curve is FAN3 and a lower curve is FAN0. During an actual experimental test, six fans 40 are set, where three fans 40 numbered from FAN0 to FAN2 are more far away from the graphics processing unit and exert smaller impact on the graphics processing unit, and three fans 40 numbered from FAN3 to FAN5 are closer to the graphics processing unit and exert larger impact on the graphics processing unit. Therefore, a weight set for the three fans FAN0-2 by the graphics processing unit is 80%, and a weight set for the three fans FAN3-5 by the graphics processing unit is 100% such that an order of the rotation speeds of six fans 40 is: FAN5=FAN4=FAN3>FAN2=FAN1>FAN0.

A final result of the experiment shows that power consumption of the graphics processing unit during a cycle first decreases rapidly and then increases rapidly, causing temperature of the graphics processing unit, rotation speed of fan 40, power consumption of fan 40, and total power consumption of the overall system to decrease rapidly and then to increase rapidly. Therefore, an effective PID control strategy is proposed, power consumption of fan 40 is limited within a reasonable range by limiting the maximum rotation speed of fan 40, thereby achieving a goal of reducing the maximum transient total power consumption of the overall system and meeting the requirements of avoiding power consumption peaks.

In addition, it should be noted that although the above-mentioned strategy is based on an experiment result obtained from a pressure testing software which conducts actual loading pressurization on the graphics processing unit, the strategy can still be applied to other configurations of overall system and system platform that have severe fluctuations in power consumption and strict requirements for total power consumption of the overall system.

It should be noted that because the maximum rotation speed of fan 40 is limited by the technical solution, in a certain circumstances, for example, when the baseboard management controller 20 is dead, temperature of the element 10 such as a central processing unit suddenly exceeds a limit, or fan 40 disfunctions and so forth, it may result in that the rotation speed of fan 40 is still the set maximum rotation speed; hence, phenomenon not appear when setting other high rotation speeds for fan 40 may appear, and consequently, a priority order needs to be adjusted accordingly for the strategy in all speed control mechanisms in the baseboard management controller 20.

After conducting actual testing on the graphics processing unit using a loading pressure testing software, it is found that power consumption of the graphics processing unit first decreases rapidly and then increases rapidly, causing quick decreasing and then quick increasing of the temperature of the graphics processing unit, the rotation speed of fan 40, the power consumption of fan 40, and the total power consumption of the overall system. Therefore, an effective control strategy is provided by the present disclosure, which has the following advantages.

1. A maximum rotation speed of fan 40 is limited, such that a maximum power consumption of fan 40 is reduced.

2. The power consumption curve of the overall system is relatively smooth with no abrupt power consumption peaks, which leads to low impact on power supply equipment and is beneficial to prolonging service life of the equipment.

3. It is only needed to create a certain level of incrementation or reduction in the speed control instruction in the baseboard management controller 20 with low difficulties and low cost to modify.

In view of the above, since the method for controlling total power consumption of the system by setting maximum rotation speed of fan 40 is to determine whether fan 40 reaches maximum rotation speed to control the system total power consumption, the present disclosure can effectively achieve a relatively stable total power consumption of the system.

The above-mentioned preferred embodiments are illustrated in the hope that features and spirits of the present disclosure are described more clearly, yet the scope of the present disclosure shall not be limited by using the above-mentioned preferred embodiments being disclosed. On the contrary, the objective is to cover various alternations and equivalent arrangements within the intended scope of the present disclosure.

What is claimed is:

1. A method for controlling total power consumption of a system by setting a maximum rotation speed of a fan, which is applied to a system at least comprising a heat-generating element, the fan and a controller, wherein the method comprises:
setting a controller with a maximum rotation speed limit value of the fan;
reading a rotation speed of the fan by the controller; and
determining, by the controller, whether the rotation speed of the fan reaches the maximum rotation speed limit value; if determination result is positive, setting, by the controller, a pulse-width modulation value of the fan as a pulse-width modulation value upper limit corresponding to the maximum rotation speed limit value; providing a feedback for the fan through the controller to control total power consumption of the system.

2. The method of claim 1, wherein the heat-generating element is a graphics processing unit (GPU).

3. The method of claim 1, wherein the controller is a baseboard management controller.

4. The method of claim 1, further comprising: determining, by the controller, whether to launch a PID speed control strategy.

5. The method of claim 4, wherein the controller has PID control values, which are a proportional coefficient, an integral coefficient, and a derivative coefficient respectively.

6. The method of claim 1, wherein the maximum rotation speed limit value is 75% to 81% of a maximum rotation speed value of the fan.

7. The method of claim 6, wherein the maximum rotation speed limit value is 78% of the maximum rotation speed value of the fan.

8. The method of claim 1, wherein if the controller determines that the rotation speed of the fan does not reach the maximum rotation speed limit value, the controller sets the pulse-width modulation value of the fan to be a current pulse-width modulation value corresponding to the rotation speed.
